(19) United States
(12) Patent Application Publication
(10) Pub. No.: US 2014/0156943 A1
(43) Pub. Date: Jun. 5, 2014

(54) INFORMATION PROCESSING APPARATUS, INFORMATION PROCESSING METHOD, AND PROGRAM

(71) Applicant: CANON KABUSHIKI KAISHA, Tokyo (JP)

(72) Inventor: Manabu Sato, Yokohama-shi (JP)

(21) Appl. No.: 14/092,010

(22) Filed: Nov. 27, 2013

(30) Foreign Application Priority Data
Nov. 30, 2012 (JP) 2012-262776

(51) Int. Cl. G06F 12/08

(52) U.S. Cl. CPC G06F 12/0891
USPC 711/135

(57) ABSTRACT

An information processing apparatus includes a detection unit configured to detect a damaged file from files stored in a cache area, a determination unit configured to determine whether the damaged file detected by the detection unit is restorable, a restoration unit configured to, if the determination unit determines that the damaged file is restorable, delete every restorable file in the cache area including the damaged file and restore the deleted file in the cache area, and an initialization unit configured to, if the determination unit determines that the damaged file is not restorable, delete every file in the cache area and initialize the cache area.

### BACKGROUND

1. Field

Aspects of the present invention generally relate to an information processing apparatus, an information processing method, and a program.

2. Description of the Related Art

In a system with a cache, when power is cut off during writing of data to a cache file, the data may be written to the cache file which is in a damaged state. Reading this damaged cache file may cause a malfunction in the system or an application. As a measure against such damaged cache file, all cache files may be deleted to return the cache to the state immediately after manufacture. Alternatively, there are other techniques as described below.

Japanese Patent Application Laid-Open No. 2011-76367 describes a technique that holds a power-off flag signal which indicates whether termination processing has been executed prior to power-off, and that repairs a file system constructed in an external storage device if the power-off flag signal indicates that the termination processing has not been executed prior to power-off.

Japanese Patent Application Laid-Open No. 2010-97560 describes a technique that allows a data file area to store a plurality of data each corresponding to each operation, and that provides a backup area for the data. When any one of the operations is selected from an operation menu, the data file corresponding to the operation is copied to the backup area before starting data processing of the operation. If an application program is forcibly terminated during the data processing, the file stored in the backup area is restored in the data file area.

Japanese Patent Application Laid-Open No. 2008-18666 describes a technique that sets the same unique data in the first and last parts of an operation panel program. If a mismatch between the unique data is detected when the operation panel program is started, the damaged operational panel program is automatically restored.

Deleting all cache files unwillingly delete all files in the cache. Thus, when the cache stores data used by an application, such data is also deleted.

The technique described in Japanese Patent application Laid-Open No. 2011-76367 determines whether processing has been completed before power-off and, if determining that the processing has not been completed, performs restoration processing. Thus, the technique described in Japanese Patent Application Laid-Open No. 2011-76367 can perform restoration processing only considering the fact that file damage has occurred. The techniques described in Japanese Patent Application Laid-Open Nos. 2010-97560 and 2008-18666 previously store files required for restoration in a device, and conduct restoration processing using the files when file damage has occurred. Thus, the files required for restoration take up the resources of the device. Furthermore, the technique described in Japanese Patent Application Laid-Open No. 2008-18666 cannot handle a trouble when a file required for restoration is not present in a device.

### SUMMARY

Aspects of the present invention are generally directed to a technique that can restore a damaged file without taking up resources or deleting user data if the damaged file is restorable. Aspects of the present invention also generally directed to a technique that can handle a system startup failure even when an unrestorable file is damaged.

According to an aspect of the present invention, an information processing apparatus includes a detection unit configured to detect a damaged file from files stored in a cache area, a determination unit configured to determine whether the damaged file detected by the detection unit is restorable, a restoration unit configured to, if the determination unit determines that the damaged file is restorable, delete every restorable file in the cache area including the damaged file and restore the deleted file in the cache area, and an initialization unit configured to, if the determination unit determines that the damaged file is not restorable, delete every file in the cache area and initialize the cache area.

Further features of the present disclosure will become apparent from the following description of exemplary embodiments with reference to the attached drawings.

### BRIEF DESCRIPTION OF THE DRAWINGS

FIG. 1 is a diagram illustrating an example of a hardware configuration of a damaged file handling device.

FIG. 2 is a diagram illustrating an example of a software configuration of a damaged file handling device.

FIG. 3 is a diagram illustrating an example of a directory configuration of a storage device.

FIG. 4 is a diagram illustrating an example of functions of a framework.

FIG. 5 is a diagram illustrating an example of functions of startup processing performed by a damaged file handling device and of information used in the startup processing.

FIG. 6 is a flowchart illustrating an example of processing performed by a damage handling unit.

FIG. 7 is a flowchart illustrating an example of processing performed by an application startup preparing unit.

FIG. 8 is a flowchart illustrating an example of processing performed by an application startup unit.

FIG. 9 is a flowchart illustrating an example of processing performed by a management information reading unit.

FIG. 10 is a flowchart illustrating an example of processing performed by a management information writing unit.

FIG. 11 is a flowchart illustrating an example of processing performed by an application monitoring unit.

### DESCRIPTION OF THE EMBODIMENTS

Various exemplary embodiments, features, and aspects will be described in detail below with reference to the drawings.

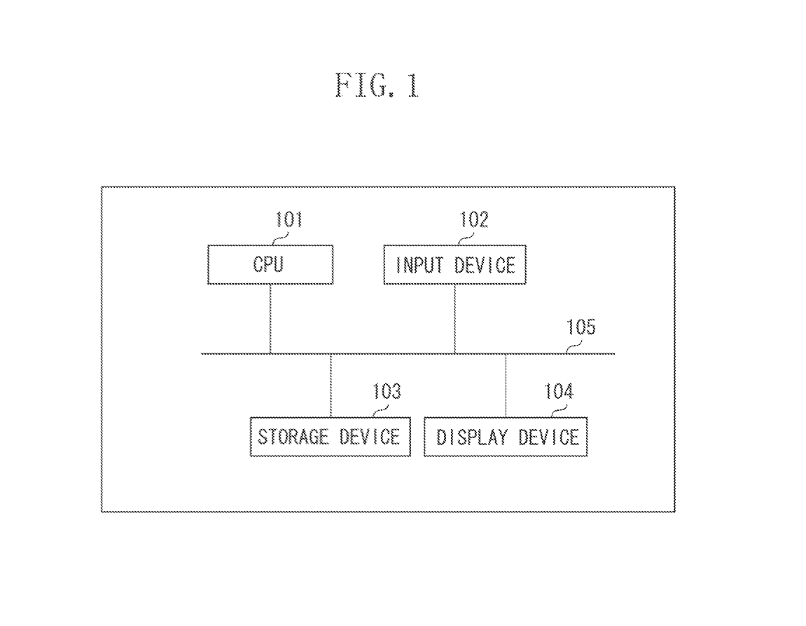

FIG. 1 is a diagram illustrating an example of a hardware configuration of a damaged file handling device according to an exemplary embodiment.

The hardware configuration of the damaged file handling device includes a central processing unit (CPU) 101, an input device 102, a storage device 103, and a display device 104. Here, the damaged file handling device is an example of an information processing apparatus.

The CPU 101 executes a program stored in the storage device 103 to realize the functions (software configuration) of the damaged file handling device and the processing of flow charts, which are described later.

The input device 102 is a device that allows a user to input data, such as a key board, a mouse, or a touch display.

The storage device 103 is a hard disk or a random access memory (RAM), which stores user data required for execution of programs and applications.

The display device 104 is configured to show various kinds of information to a user.

The CPU 101, the input device 102, the storage device 103, and the display device 104 are connected to one another via a bus 105.

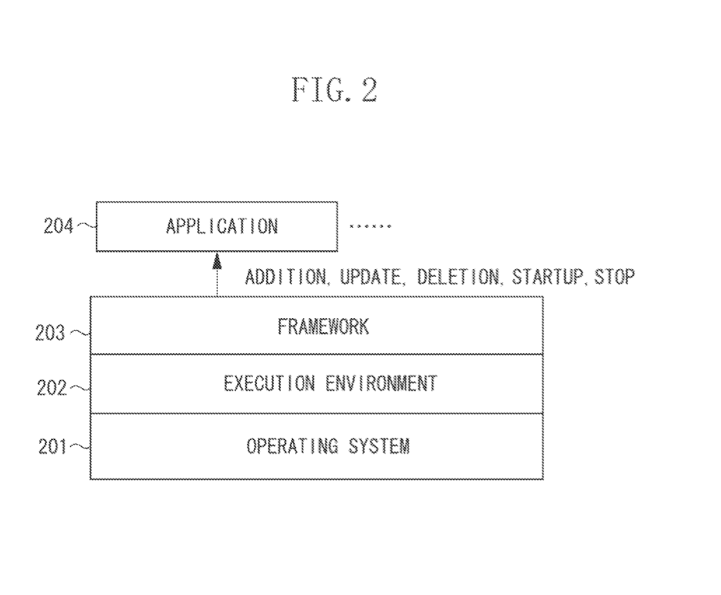

FIG. 2 is a diagram illustrating an example of a software configuration of the damaged file handling device according to the exemplary embodiment.

The software configuration of the damaged file handling device includes an operating system 201, an execution environment 202, a framework 203, and an application 204.

The operating system 201 is software that serves as a system platform.

The execution environment 202 runs on the operating system 201 and provides an environment that allows the application 204 to run thereon.

The framework 203 is software configured to manage the operating state of the application 204. In this exemplary embodiment, the Open Services Gateway Initiative (OSGi) framework is used as a framework 203 for managing dynamic installation and execution of a Java (registered trademark) module.

The framework 203 describes information on the installed application 204, such as the startup sequence, the state, the storage location of data to be used (hereinafter, referred to as “management information”) in a file (hereinafter, referred to as a “management file”). Thus, the framework 203 uses the information to manage the application 204. The framework 203 is configured to read the management file at startup and to reproduce the same state as that of the last startup. When the management information needs to be modified due to installation, update, or state change of the application 204, the framework 203 updates the management file accordingly. The management file is created separately depending on the information held in the damaged file handling device. Thus, a plurality of the management files may exist.

In this exemplary embodiment, the phrase “installation of the application 204” more specifically means installation of an application file to be executed by the CPU 101 to implement the function of the application 204. For convenience of description, however, the phrase “installation of the application 204” will be used even in the case of installation of the application file.

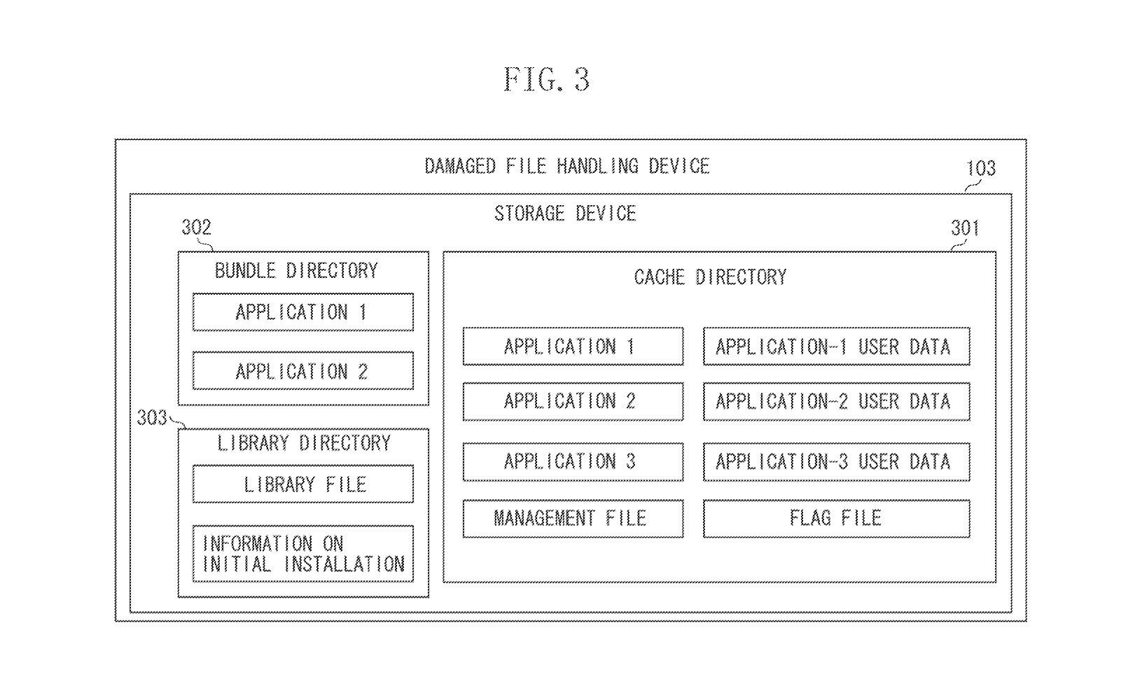

FIG. 3 is a diagram illustrating an example of a directory configuration of the storage device 103.

The storage device 103 includes a cache directory 301, a bundle directory 302, and a library directory 303.

The cache directory 301 stores the installed application 204, user data to be used by the application 204, the management file, a flag file described later, and the like.

When the application 204 is installed in the cache directory 301, the framework 203 creates a directory and stores the installed application 204 itself and the user data into the directory. In addition, the framework 203 stores a management file that describes a relationship between the application 204 and the user data in the cache directory 301.

The bundle directory 302 stores the application 204 required for operating the damaged file handling device. The application 204 is used at the initial startup of the damaged file handling device.

The library directory 303 stores a library file to be used by the damaged file handling device. In addition, the library directory 303 stores a file that describes information on initial installation, such as applications to be installed at initial startup and the installation order of applications.

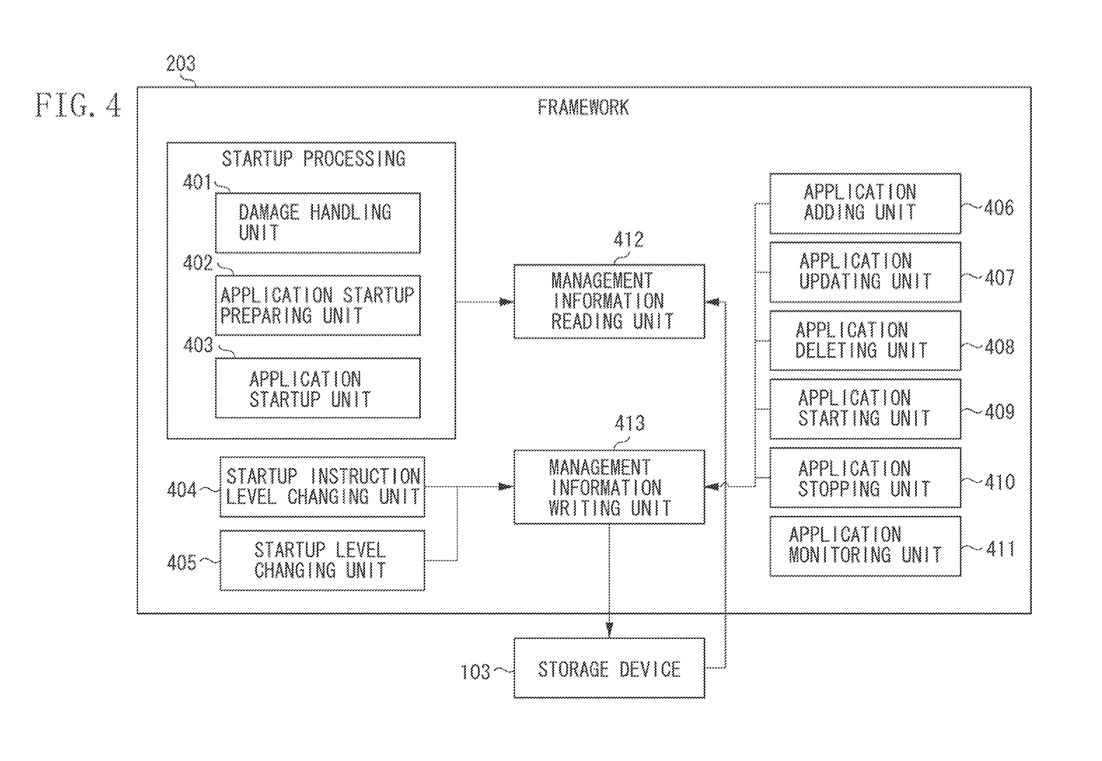

Next, the operation of the framework 203 will be described with reference to FIG. 4.

FIG. 4 is a diagram illustrating an example of functions of the framework 203.

In the startup processing, the framework 203 determines whether a problem occurred in the management file or the application 204 during the last operation, followed by causing the corresponding damage handling unit 401 to execute processing. Subsequently, the framework 203 executes processing by an application startup preparing unit 402 that reads the application 204 stored in the cache directory 301, and by an application startup unit 403 that starts up the application 204. Here, the application 204 managed by the framework 203 includes a startup level to be referenced at startup. On the other hand, the framework 203 includes a startup instruction level that determines which applications 204 to be started by its startup level.

The application startup unit 403 sequentially starts up the applications 204 which have a startup level not higher than the startup instruction level of the framework 203. Furthermore, the framework 203 includes a startup instruction level changing unit 404 as a function which allows the user to change the startup instruction level. Similarly, the framework 203 has a startup level changing unit 405 as a function which allows the user to change the startup level of the application 204.

The framework 203 controls the operating state of the application 204. In other words, the framework 203 has functions to install, update, uninstall, start, and stop the application 204. In the present exemplary embodiment, these functions are respectively referred to as an application adding unit 406, an application updating unit 407, an application deleting unit 408, an application starting unit 409, and an application stopping unit 410. Furthermore, the framework 203 uses an application monitoring unit 411 to check whether a trouble has occurred at startup or during operation of the application 204.

At startup, the framework 203 uses a management information reading unit 412 to read a management file stored in a hard disk of the storage device 103 and then to store the contents of the management file in a RAM of the storage device 103. Subsequently, the framework 203 performs processing based on the contents of the management file, the management information, stored in the RAM of the storage device 103. Upon update of the management information, the framework 203 uses a management information writing unit 413 to write the updated management information into the management file in the hard disk. The framework 203 uses the startup instruction level changing unit 404 and the startup level changing unit 405 to update various kinds of levels. Furthermore, the framework 203 allows the application adding unit 406, the application updating unit 407, the application deleting unit 408, the application starting unit 409, and the application stopping unit 410 to update the information on the application 204.

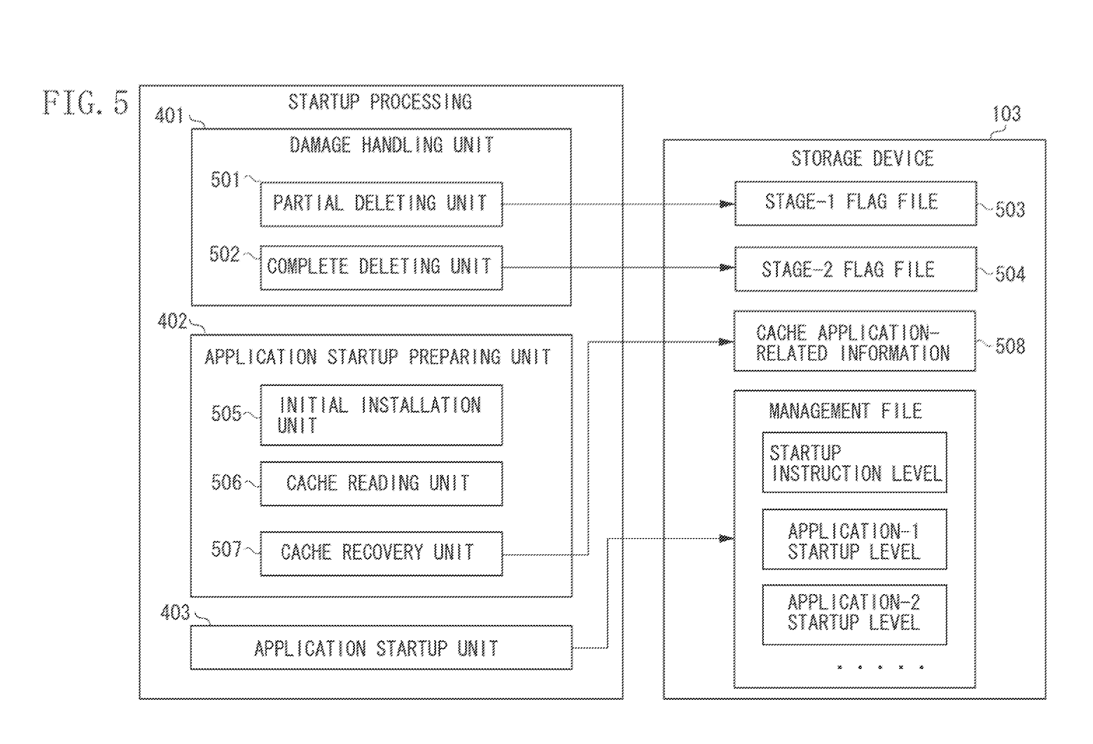

Referring now to FIG. 5, the startup processing of the damaged file handling device will be described.

FIG. 5 is a diagram illustrating an example of functions of startup processing performed by the damaged file handling device and of information to be used in the startup processing.

The functions of startup processing performed by the damaged file handling device can be mainly classified into three functions: the damage handling unit 401, the application startup preparing unit 402, and the application startup unit 403.

First, the damage handling unit 401 will be described.

The damage handling unit 401 includes a partial deleting unit 501 and a complete deleting unit 502 as functions thereof, and utilizes a stage-1 flag file 503 and a stage-2 flag file 504 as pieces of information.

The stage-1 flag file 503 and the stage-2 flag file 504 are flag files indicating that damage occurred in the management file and/or the application 204 during the last operation. The details of the flag files will be described later.

The damaged file handling device stores the application 204 required for the operation in the bundle directory 302. Thus, even if the application 204 stored in the bundle directory 302 has been removed from the cache directory 301, the damaged file handling device 103 can reinstall the application 204. When the damaged file handling device is connected to a communicable network, the damaged file handling device may store the application 204 on the network to reinstall the application 204 therefrom.

Furthermore, some of the management files can be recreated based on the information on initial installation stored in the library directory 303. The presence of the stage-1 flag file 503 in the cache directory 301 means that a reinstallable or recreatable file is damaged. Here, the above-mentioned reinstallable or recreatable file is an example of a restorable file. Furthermore, as described above, processing of reinstalling or recreating a damaged file in a cache area based on the file in the bundle directory, the file on the network, or the file in the library directory is an example of restoration processing.

Furthermore, the framework 203 can install the application 204, which has not been stored in the bundle directory 302, by using the application adding unit 406. However, since the application 204 is not in the bundle directory 302, the damaged file handling device cannot perform reinstallation and recreation after removal of the application 204 from the cache directory 301. Thus, the presence of the stage-2 flag file 504 in the cache directory 301 indicates that a file, which cannot be reinstalled or recreated, has been damaged. Here, the above-mentioned unreinstallable or unrecreatable file is an example of an unrestorable file.

When the stage-1 flag file 503 is in the cache directory 301, the partial deleting unit 501 deletes the reinstallable application 204 or the recreatable management file, which is stored in the cache directory 301 and can be re-installed or re-created. At this time, the partial deleting unit 501 deletes not only the damaged file but also all the recreatable and reinstallable files in the cache directory 301.

The partial deleting unit 501 deletes not only the damaged file but also all the recreatable and reinstallable files in order to ensure consistency between the management files. Information used for management file recreation held by the damaged file handling device does not include any change made to the application 204 after installation. Thus, the damaged file handling device recreates a management file based on the information obtained immediately after installation. If the damaged file handling device recreates only the damaged management file, the damaged file handling device may not properly run because of inconsistency between the recreated management file and the non-recreated management file. The damaged file handling device therefore recreates a management file after deleting all the recreatable management files to maintain the consistency. The damaged file handling device deletes the reinstallable application 204 but does not delete user data that cannot be recreated based on the information held by the damaged file handling device.

On the other hand, the complete deleting unit 502 deletes all the files in the cache directory 301 including the user data of the respective applications 204 when the stage-2 flag file 504 is in the cache directory 301.

Next, the application startup preparing unit 402 will be described.

The application startup preparing unit 402 includes an initial installation unit 505, a cache reading unit 506, and a cache recovery unit 507 as functions, and uses cache application-related information 508 as information thereof.

In a state that no application 204 has been installed, for example, in a state immediately after shipment of the damaged file handling device, the initial installation unit 505 executes processing such as initial installation. More specifically, the initial installation unit 505 performs installation of the application 204 stored in the bundle directory 302 and creation of a new management file. Here, when the complete deleting unit 502 has deleted all the files in the cache directory 301, the initial installation unit 505 installs the application 204 stored in the bundle directory 302 and creates a new management file.

When the application 204 has been already installed in the damaged file handling device, the cache reading unit 506 reads the cache directory 301. More specifically, the cache reading unit 506 reads information on the application 204 that has been installed and stored in the cache directory 301 to prepare for startup of the application 204.

When the partial deleting unit 501 deletes the reinstallable or recreatable file in the cache directory 301, the cache recovery unit 507 executes processing for restoring the deleted file. More specifically, the cache recovery unit 507 performs processing for reinstallation of the application 204 deleted by the partial deleting unit 501 or recreation of the management file or processing for returning the application 204 to the initial state thereof.

First, the processing for reinstallation of the application 204 or recreation of the management file, deleted by the partial deleting unit 501 will be described.

The application 204 deleted by the partial deleting unit 501 is stored in the bundle directory 302. Thus, the cache recovery unit 507 can reinstall the application 204 by referring to the bundle directory 302.

On the other hand, the cache recovery unit 507 can recreate a management file, which has been deleted by the partial deleting unit 501, based on necessary information collected from the information on initial installation stored in the library directory 303. However, the set values included in the description of the management file recreated by the cache recovery unit 507 are the initial values (i.e. the values specified for the application 204 immediately after installation). This is because information used for recreating the management file does not include any change made to the application 204 after installation. Furthermore, the cache recovery unit 507 uses cache application-related information 508 to recreate the management file that describes the relationship between the user data, which has not been deleted by the partial deleting unit 501, and the application 204. Here, the cache application-related information 508 is backup information provided for any possible damage to the management file which includes information associating the application 204 with the user data. More specifically, the cache application-related information 508 is information associating the installed application 204 and the user data, and is created by the damaged file handling device. Here, creation of the cache application-related information 508 is an example of related information creation processing.

Next, processing for returning the application 204 to the initial state by the application startup preparing unit 402 will be described.

In the damaged file handling device, the applications 204 may have dependence relationships with each other. The dependence relationship is, for example, a case where operating an application A requires an application B to be operated in advance. In the damaged file handling device where the applications 204 having such a dependence relationship are installed, the dependence relationship may be lost if the set values of the recreatable management file are changed to the initial set values. As a result, an error may occur at startup. To avoid such a situation, the application startup preparing unit 402 needs to change the states of all the installed applications 204 to the initial states thereof. Here, the term “initial state” means a state being set to the state of the application 204 immediately after installation.

The damaged file handling device installs the application 204 that has been stored in the bundle directory 302 at initial startup, based on the information on the initial installation stored in the library directory 303. In such a manner, if the application 204 is installed at initial startup, the state specified at initial startup is considered as the initial state. On the other hand, if the application 204 has not been installed at initial startup, the stopped state thereof is considered as the initial state. Thus, the operating state of the respective applications 204 can be equal to the state at initial startup thereof by changing the states of all the applications 204 to the initial states. As a result, the damaged file handling device can be prevented from causing any error due to the dependence relationship.

Next, processing performed by the application startup unit 403 is described.

As mentioned above, the application startup unit 403 allows the applications 204 having a startup level not higher than the startup instruction level of the framework 203 to start up in the order from the one having the lowest startup level. However, the started application 204 here is only the application 204 whose last state is described as running in the management file.

As described above, when the management file or the application 204 is damaged, the damaged file handling device uses the damage handling unit 401 to delete the damaged file, and then uses the application startup preparing unit 402 to reinstall or recreate the file. Subsequently, the application startup unit 403 uses the reinstalled or recreated file to start the application 204 as usual. Thus, when the reinstallable or recreatable file is damaged, the damaged file handling device can restore the file without deleting user data. Furthermore, even if an unrestorable file is damaged, the damaged file handling device can properly start the system.

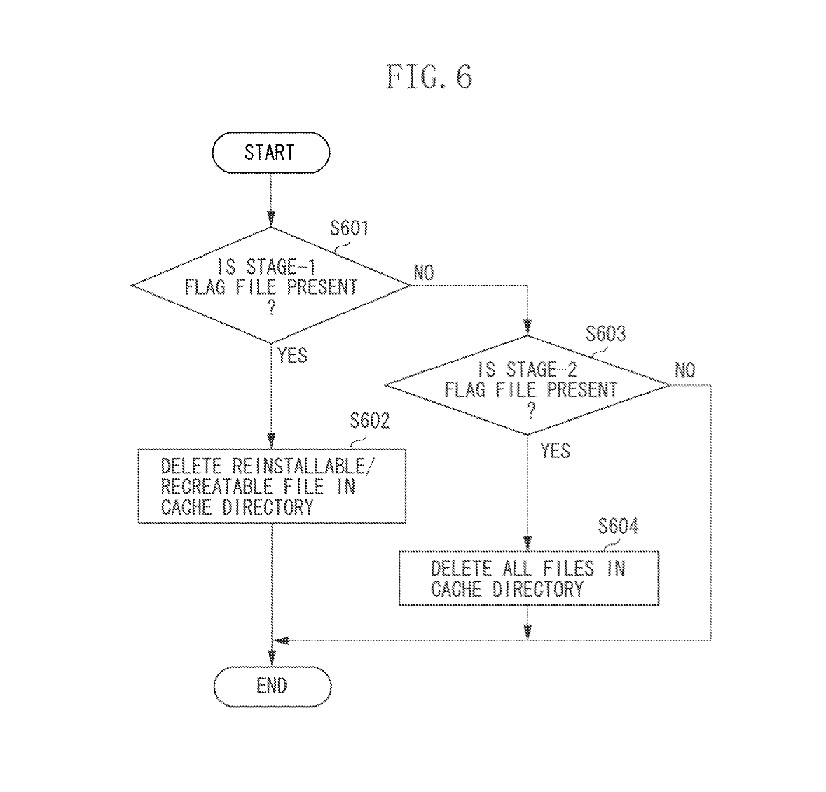

Next, the operation of the damage handling unit 401 will be described with reference to FIG. 6.

FIG. 6 is a flowchart illustrating an example of processing performed by the damage handling unit 401.

In step S601, the damage handling unit 401 first checks whether the stage-1 flag file 503 is present in the cache directory 301.

In step S602, the stage-1 flag file 503 is present, the damage handling unit 401 determines that a recreatable or reinstallable file in the cache directory 301 has been damaged, and then deletes every recreatable or reinstallable file in the cache directory 301. As described above, in step S602, the damage handling unit 401 does not delete user data to be used by each application 204.

On the other hand, in step S603, if the stage-1 flag file 503 is not present, the damage handling unit 401 checks whether the stage-2 flag file 504 is present in the cache directory 301.

In step S604, if the stage-2 flag file 504 is present, the damage handling unit 401 determines that a file in the cache directory 301, which cannot be recreated or reinstalled, is damaged and then deletes all the files in the cache directory 301 including the user data.

Furthermore, if neither the stage-1 flag file 503 nor the stage-2 flag file 504 is present, the damage handling unit 401 determines that no file is damaged, thereby performing no processing for handling a damaged file.

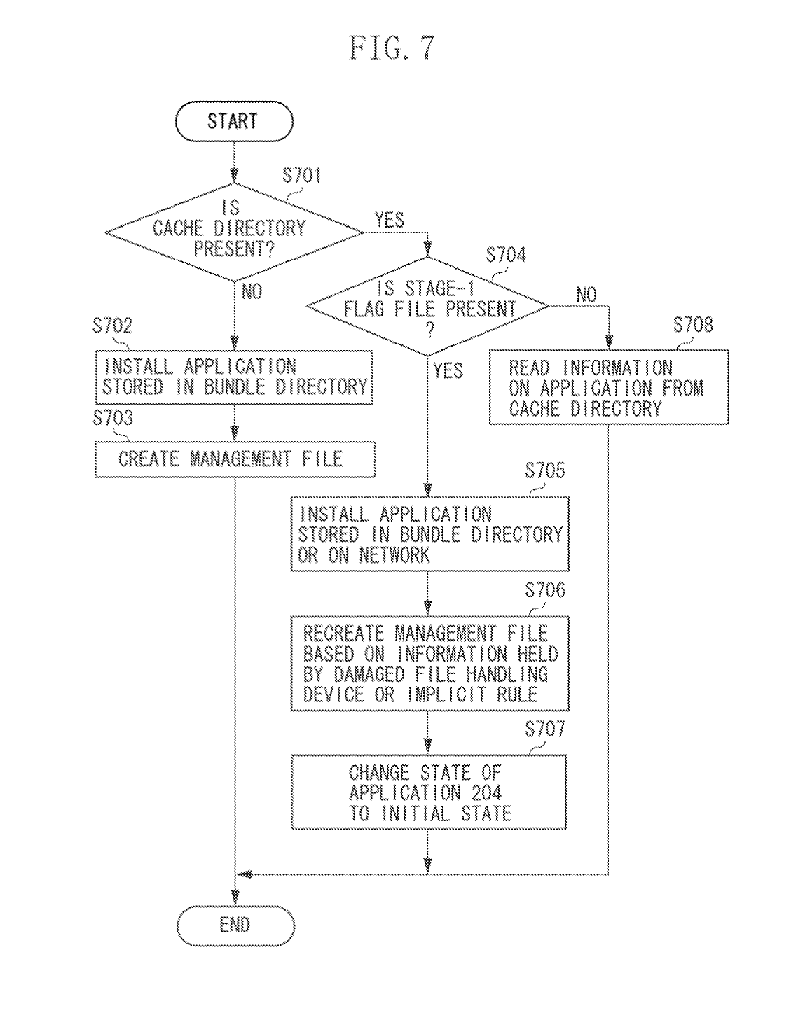

Next, the operation of the application startup preparing unit 402 will be described with reference to FIG. 7.

FIG. 7 is a flowchart illustrating an example of processing performed by the application startup preparing unit 402.

First, in step S701, the application startup preparing unit 402 checks whether the cache directory 301 is present.

In step S702, if the cache directory 301 is not present, the application startup preparing unit 402 determines that no application 204 has been installed, and then installs the application 204 stored in the bundle directory 302. Executing the processing in step S702 after deleting all the files in the cache directory 301 in step S604 means that the cache directory 301 is initialized.

Subsequently, in step S703, the application startup preparing unit 402 creates a new management file that describes management information, including the startup instruction level held by the framework 203, and the startup levels of the respective applications 204.

On the other hand, in step S704, if the cache directory 301 is present, the application startup preparing unit 402 checks whether the stage-1 flag file 503 is present in the cache directory 301.

In step S705, if the stage-1 flag file 503 is present, the application startup preparing unit 402 determines that the damage handling unit 401 has deleted a recreatable or reinstallable file, and reinstalls the deleted application 204 from the bundle directory 302 or the network.

Then, in step S706, the application startup preparing unit 402 recreates the deleted management file based on the information on initial installation held by the damaged file handling device.

Finally, in step S707, the application startup preparing unit 402 changes the state of the application 204 to the initial state to avoid an error at startup.

In step S708, if the stage-1 flag file 503 is not present, the application startup preparing unit 402 determines that no abnormality occurred in the last operation. Then, the application startup preparing unit 402 reads information on the application 204 stored in the cache directory 301 to prepare for startup of the application 204.

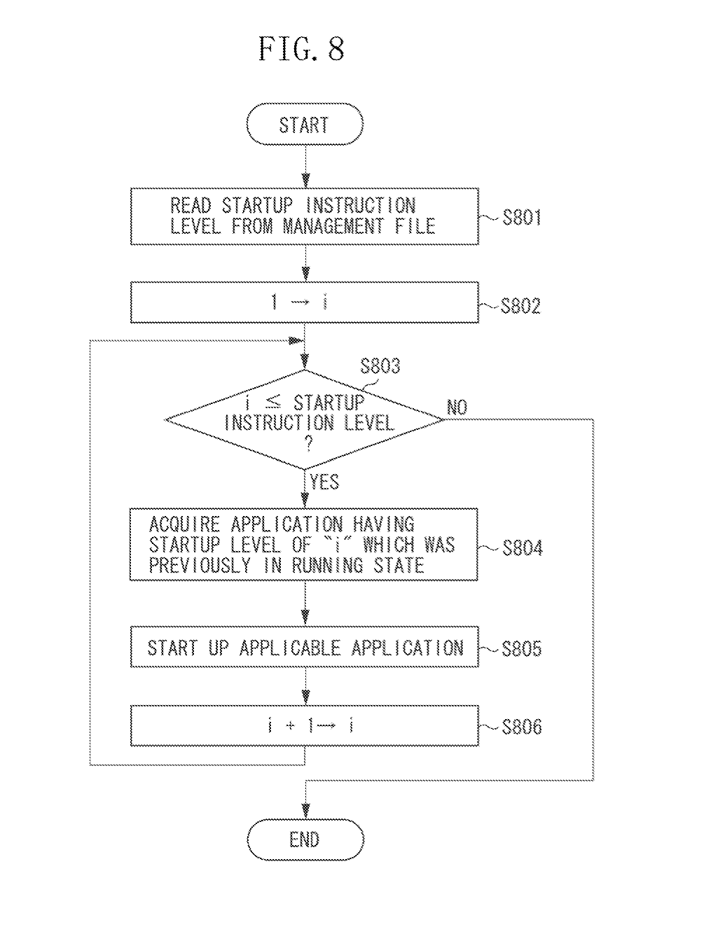

Next, the operation of the application startup unit 403 will be described with reference to FIG. 8.

FIG. 8 is a flowchart illustrating an example of processing performed by the application startup unit 403.

First, in step S801, the application startup unit 403 reads the startup instruction level included in the framework 203 from the management file.

In steps S802, S803, S804, S805, and S806, the application startup unit 403 starts up the applications 204 which have a startup level within 1 to the startup instruction level, as well as which were previously in a running state, in the order from the one having the lowest startup level.

Thus, the framework 203 handles a damaged file in the startup processing, allowing the damaged file handling device to be properly started.

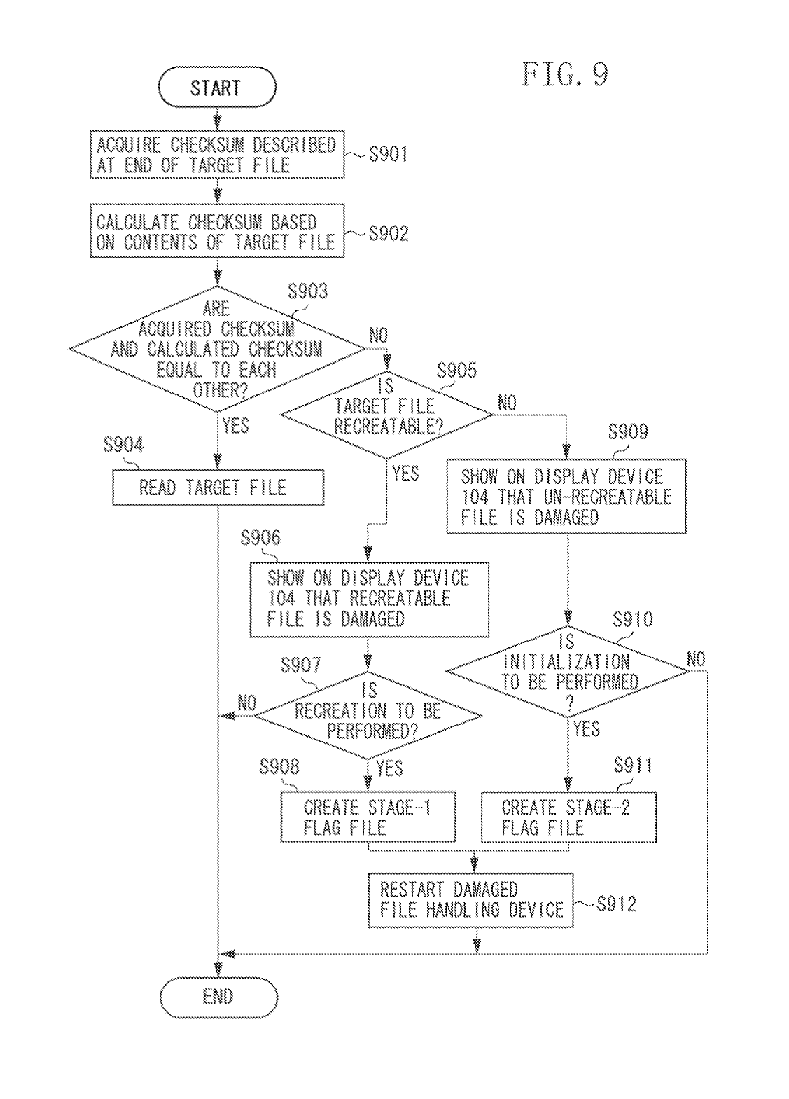

Next, the operation of the management information reading unit 412 will be described with reference to FIG. 9.

FIG. 9 is a flowchart illustrating an example of processing performed by the management information reading unit 412.

In the framework 203, the management information reading unit 412 determines whether the management file is damaged.

In step S901, the management information reading unit 412 acquires a checksum described at the end of the management file to be read. This checksum has been added by the management information writing unit 413 described later. The management information reading unit 412 uses this value to perform an operational check. Here, the checksum is an example of an error detection code.

Next, in step S902, the management information reading unit 412 calculates a checksum based on the contents of the target management file to be read.

Then, in step S903, the management information reading unit 412 determines whether the checksum acquired in step S901 matches the checksum calculated in step S902 to check if there is any damage in the management file.

In step S904, if the acquired checksum matches the calculated checksum, the management information reading unit 412 determines that the management file is not damaged, and then reads the contents of the management file and ends the processing.

In step S905, if the acquired checksum does not match the calculated checksum, the management information reading unit 412 determines that the management file has been damaged. Then, the management information reading unit 412 determines whether the damaged management file is recreatable, in order to create a flag file indicating that the file is damaged. More specifically, the management information reading unit 412 determines whether the damaged management file is recreatable, based on the information on initial installation stored in the library directory 303.

In step S906, if the management information reading unit 412 determines that the management file is recreatable, the management information reading unit 412 shows on the display device 104 that a recreatable file is damaged.

Subsequently, in step S907, the management information reading unit 412 waits for an input from the user via the input device 102 to determine whether the damaged management file needs to be recreated.

In step S908, if the management information reading unit 412 receives an input from the user via the input device 102, informing that the user desires to recreate the damaged management file, the management information reading unit 412 creates the stage-1 flag file 503 indicating that a recreatable file is damaged. Here, creation of the stage-1 flag file 503 is an example of flag file creation processing.

On the other hand, if the management information reading unit 412 receives an input from the user via the input device 102, informing that the user does not desire to recreate the damaged management file, the processing is ended.

In step S909, on the other hand, if the management information reading unit 412 determines that the damaged management file is not recreatable in step S905, the management information reading unit 412 shows on the display device 104 that an unrecreatable file has been damaged.

Then, in step S910, the management information reading unit 412 waits for an input from the user to determine whether initialization needs to performed.

In step S911, if the management information reading unit 412 receives an input from the user via the input device 102, informing that the user desires to perform initialization, the management information reading unit 412 creates the stage-2 flag file 504 indicating that an un-recreatable file has been damaged. Creation of the stage-2 flag file 504 is an example of flag file creation processing.

After creating a flag file, in step S912, the management information reading unit 412 restarts the damaged file handling device in order to restore the damaged management file. This is because the damaged file is to be handled while the damaged file handling device is in startup processing.

In the present exemplary embodiment, the management information reading unit 412 is configured to determine the presence or absence of any damage in the management file based on the result of a comparison between the checksum described in the target management file and the checksum calculated from the contents of the target management file. However, the determination procedure is not limited to such a procedure. Alternatively, for example, the framework 203 may monitor processing such as installation of files and determine that a file is damaged based on a result of the monitoring, such as improper completion of installation. The determination on whether a file is damaged as described above is an example of the damaged file detection processing.

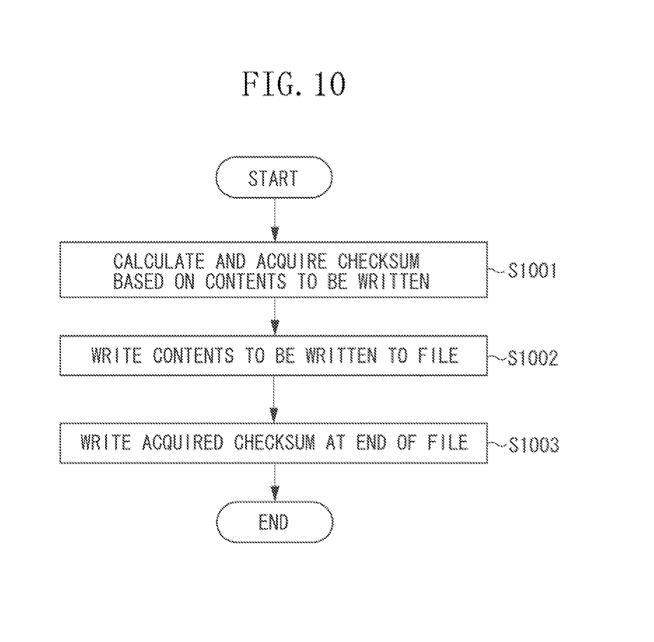

Referring now to FIG. 10, the operation of the management information writing unit 413 will be described. FIG. 10 is a flowchart illustrating an example of processing performed by the management information writing unit 413. First, in step S1001, the management information writing unit 413 calculates and acquires a checksum based on contents to be written to the management file. As described in FIG. 9, the checksum calculated in step S1001 is compared with the checksum acquired from the contents read by the management information reading unit 412 to determine whether the file is damaged.

Next, in step S1002, the management information writing unit 413 writes the contents to be written to the file.

Subsequently, in step S1003, the management information writing unit 413 writes the checksum calculated and acquired in step S1001 at the end of the file.

Thus, the framework 203 uses the management information writing unit 413 to embed in the file the checksum to be used to check for damage. Subsequently, the framework 203 uses the management information reading unit 412 to determine whether the file is damaged by using the checksum. Thus, the framework 203 prevents the damaged file handling device from being disabled due to a damaged management file.

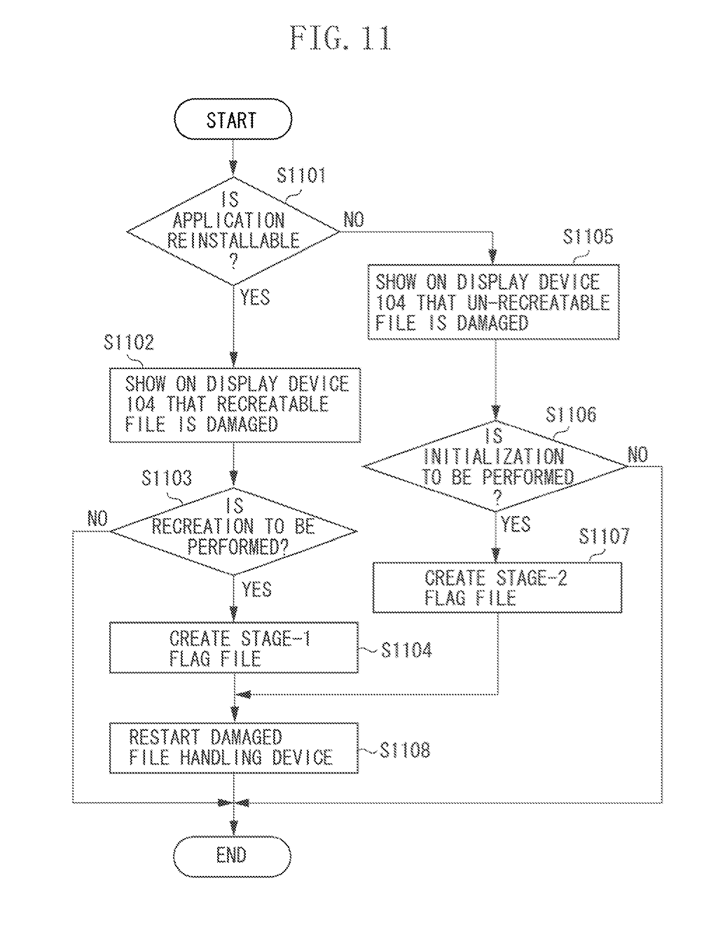

Next, the operation of the application monitoring unit 411 will be described with reference to FIG. 11.

FIG. 11 is a flowchart illustrating an example of processing performed by the application monitoring unit 411.

The framework 203 controls the state of the application 204. For this purpose, the application monitoring unit 411 is capable of detecting abnormalities, such as damage to the application 204. Here, the detection of abnormalities, such as damage to the application 204 is an example of detection processing. The application monitoring unit 411 detects and handles an exceptional event during the operation of the application 204.

In step S1101, if the application monitoring unit 411 detects any abnormality in the application 204, the application monitoring unit 411 determines whether the application 204 is reinstallable. More specifically, if the application 204 having the abnormality detected in step S1101 is the application 204 stored in the bundle directory 302 or on the network, the application monitoring unit 411 determines that the application 204 is reinstallable.

In step S1102, if the application monitoring unit 411 determines that the application 204 having an abnormality is reinstallable, the application monitoring unit 411 notifies the user via the display device 104 that a reinstallable file is damaged.

Subsequently, in step S1103, the application monitoring unit 411 waits for an input from the user via the input device 102 to determine whether the reinstallation needs to be performed.

In step S1104, if the application monitoring unit 411 receives an input from the user via the input device 102, informing that the user desires to perform the reinstallation, the application monitoring unit 411 creates the stage-1 flag file 503 indicating that a reinstallable file has been damaged. Creation of the stage-1 flag file 503 is an example of flag file creation processing.

On the other hand, in step S1105, if the application monitoring unit 411 determines that the application 204 having an abnormality cannot be reinstalled, the application monitoring unit 411 notifies the user via the display device 104 that an unrecreatable file is damaged.

Subsequently, in step S1106, the application monitoring unit 411 waits for an input from the user via the input device 102 to determine whether initialization of the cache directory 301 needs to be performed.

In step S1107, if the application monitoring unit 411 receives an input from the user via the input device 102, informing that the user desires to perform initialization of the cache directory 301, the application monitoring unit 411 creates the stage-2 flag file 504 indicating that an unrecreatable file has been damaged. Creation of the stage-2 flag file 504 is an example of flag file creation processing.

Then, in step S1108, the application monitoring unit 411 restarts the damaged file handling device to handle the application 204 having an abnormality.

Thus, the framework 203 uses the application monitoring unit 411 to detect damage to the application 204, thereby preventing the damaged file handling device from being disabled.

In the present exemplary embodiment, the application monitoring unit 411 is configured to determine whether to reinstall a application 204 and whether to initialize a cache directory 301, based on an input from the user via the input device 102. However, the determination procedure is not limited to such a procedure. Alternatively, for example, the application monitoring unit 411 may determine whether the reinstallation or the initialization need to be performed, based on predetermined settings.

Additional embodiments can also be realized by a computer of a system or apparatus that reads out and executes computer executable instructions recorded on a storage medium (computer-readable storage medium) to perform the functions of one or more of the above-described embodiment(s), and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to each of the exemplary embodiments described above, if a restorable file is damaged, the damaged file can be restored without taking up resources or deleting user data in the cache. Furthermore, a system startup failure can be handled even when an unrestorable file is damaged.

According to the exemplary embodiment, if a restorable file is damaged, the damaged file can be restored without taking up resources or deleting user data in the cache. Furthermore, a system startup failure can be handled even when an unrestorable file is damaged.

While the present disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-262776 filed Nov. 30, 2012, which is hereby incorporated by reference herein in its entirety.

What is claimed is:

1. An information processing apparatus comprising:
a detection unit configured to detect a damaged file from files stored in a cache area;
a determination unit configured to determine whether the damaged file detected by the detection unit is restorable;
a restoration unit configured to, if the determination unit determines that the damaged file is restorable, delete every restorable file in the cache area including the damaged file and restore the deleted file in the cache area; and
an initialization unit configured to, if the determination unit determines that the damaged file is not restorable, delete every file in the cache area to initialize the cache area.

2. The information processing apparatus according to claim 1, wherein if the deleted file is an application file required for operating the information processing apparatus, the restoration unit restores the deleted file based on a file in a bundle directory that stores an application file.

3. The information processing apparatus according to claim 1, wherein if the deleted file is a management file required for executing an application file, the restoration unit restores the deleted file based on a file in a library directory that stores a file that describes information on initial installation of an application file.

4. The information processing apparatus according to claim 1, further comprising a flag file creation unit configured to create a flag file describing information on whether the damaged file detected by the detection unit is restorable, and to restart the information processing apparatus,
wherein the determination unit determines whether the damaged file is restorable based on the flag file created by the flag file creation unit, after the restart of the information processing apparatus by the flag file creation unit.

5. The information processing apparatus according to claim 1, wherein the restorable file is a file that can be reinstalled or recreated based on a file being held or a file stored on a communicable network, and
wherein the determination unit determines whether the damaged file detected by the detection unit is restorable.

6. The information processing apparatus according to claim 1, wherein the detection unit detects a damaged file based on whether an error detection code described in a file stored in the cache area matches an error detection code calculated and acquired from contents of the file.

7. The information processing apparatus according to claim 1, wherein if installation processing of a file stored in the cache area is not properly completed, the detection unit detects the file as a damaged file.

8. The information processing apparatus according to claim 1, further comprising a receiving unit configured to receive an instruction from a user via an input device,
wherein if the receiving unit receives an instruction for executing restoration of a damaged file, the restoration unit deletes every restorable file in the cache area and restores the deleted file in the cache area, and
wherein if the receiving unit receives an instruction for executing initialization, the initialization unit deletes every file in the cache area to initialize the cache area.

9. The information processing apparatus according to claim 1, further comprising a setting unit configured to previously make settings on whether to perform restoration processing by the restoration unit and to perform initialization processing by the initialization unit,
wherein if the setting unit makes a setting for executing restoration of a damaged file, the restoration unit deletes every restorable damaged file in the cache area and restores the deleted file in the cache area, and
wherein if the setting unit makes a setting for executing initialization, the initialization unit deletes every file in the cache area and initializes the cache area.

10. The information processing apparatus according to claim 1, further comprising a related information creation unit configured to, if the determination unit determines that the damaged file is restorable, create related information that associates information on a file in a bundle directory storing an application file with information on a file that is in the cache area and is required for executing the file in the bundle directory,
wherein the restoration unit deletes every restorable file in the cache area and restores the deleted file in the cache area by using the related information created by the related information creation unit.

11. An information processing apparatus comprising:
a detection unit configured to detect a damaged file from files stored in a cache area;
a determination unit configured to determine whether the damaged file detected by the detection unit is restorable;
a deletion unit configured to, if the determination unit determines that the damaged file is restorable, delete every restorable file in the cache area including the damaged file, and, if the determination unit determines that the damaged file is not restorable, delete every unrestorable file in the cache area including the damaged file; and
a restoration unit configured to, if a restorable file is deleted by the deletion unit, restore the deleted restorable file in the cache area.

12. A method for information processing executed by an information processing apparatus, the method comprising:
detecting a damaged file from files stored in a cache area;
determining whether the detected damaged file is restorable;
deleting, if it is determined that the detected damaged file is restorable, every restorable file in the cache area and restoring the deleted file in the cache area; and
deleting, if it is determined that the detected damaged file is not restorable, every file in the cache area and initializing the cache area.

13. An method for information processing executed by an information processing apparatus, the method comprising:
detecting a damaged file from files stored in a cache area;
determining whether the detected damaged file is restorable;
deleting, if it is determined that the detected damaged file is restorable, every restorable file in the cache area including the damaged file;
deleting, if it is determined that the detected damaged file is not restorable, every unrestorable file in the cache area including the damaged file; and
restoring, if the restorable file is deleted, the deleted restorable file in the cache area.

14. A computer-readable storage medium storing computer executable instructions that cause a computer to execute a method, the computer executable instructions comprising:
detecting a damaged file from files stored in a cache area;
determining whether the detected damaged file is restorable;
deleting, if it is determined that the detected damaged file is restorable, every restorable file in the cache area and restoring the deleted file in the cache area; and
deleting, if it is determined that the detected damaged file is not restorable, every file in the cache area and initializing the cache area.

15. A computer-readable storage medium storing computer executable instructions that cause a computer to execute a method, the computer executable instructions comprising:
detecting a damaged file from files stored in a cache area;
determining whether the detected damaged file is restorable;
deleting, if it is determined that the detected damaged file is restorable, every restorable file in the cache area including the damaged file;
deleting, if it is determined that the detected damaged file is not restorable, every unrestorable file in the cache area including the damaged file; and
restoring, if the restorable file is deleted, the deleted restorable file in the cache area.
